(19) United States
(12) Patent Application Publication
(10) Pub. No.: US 2021/0240941 A1
(43) Pub. Date: Aug. 5, 2021

(54) SYSTEMS AND METHODS FOR SIMULATION MODEL OF LANGUAGE

(71) Applicant: Ardis AI INC., Mountain View, CA (US)

(72) Inventors: Julie Kristen Mecca, Mountain View, CA (US); Kyle Alexander Lewis, Mountain View, CA (US)

(21) Appl. No.: 17/165,651

(22) Filed: Feb. 2, 2021

Related U.S. Application Data
(60) Provisional application No. 62/969,517, filed on Feb. 3, 2020.

(51) Int. Cl. G06F 40/35; G06N 3/00; G06N 3/04; G06F 40/295

(52) U.S. Cl. CPC G06F 40/35; G06F 40/295; G06N 3/0454; G06N 3/006

(57) ABSTRACT

Disclosed are systems and methods for simulating and modeling the mental state of a human reader of a block of text. In one embodiment, one or more parsers scan an input text and generate mental space frames and image schema frames. An entity creator generates simulation entities, which are mapped to relevant mental space and image schema frames. One or more classifiers can label the frames. A frame interpreter can generate rules, relationships and events based on the label of the frames. A pathfinder module finds ways to execute the events, in sequences and manners that do not make the generated rules, relationships and domains false. A simulation space parameter is updated with the executed events.

### CROSS-REFERENCE TO RELATED APPLICATIONS

This application claims the benefit of U.S. Provisional Application No. 62/969,517, filed Feb. 3, 2020, which is hereby incorporated by reference in its entirety.

### BACKGROUND

Natural language processing is emerging as an area of important economic and technological impact. Humans are limited in their capacity and efficiency for reading and processing the massive amounts of information that appear in textual form in modern life. At the same time, while computers have incredible potential and capacity for processing of natural language in text format, their functionality in this field has not been exploited as well as it should. Various technological challenges stand in the way of efficiently utilizing modern computers for text processing. Older approaches relied on turning text into symbolic logic, while newer, artificial intelligence-based approaches to text processing, are tailored to solving specific and narrow problems and require substantial pre-coding and hard-coding of complex concepts by human operators. Consequently, there is a substantial need for improved computerized text processing that can be applied more dynamically, with less human intervention.

### SUMMARY

Aspects of the disclosed technology include embodiments that can process an input text and generate a model that simulates the mental state of a human reader of that text. The simulated model can then be used for a variety of tasks. For example, the simulation can be queried for questions relating to the text, generating summaries of voluminous textual data, or any other comprehension and textual understanding that a human reader might be expected to perform after reading an input text.

In some embodiments, the simulation can be generated with parameters, rules, and relationships that a body of text can generate in the mind of a human reader. Parsers generate mental space frames and image schema frames, and an entity creator generates entities, resulting from a body of text. Classifiers can label the frames, based on pre-determined labels. Frame combiners can determine frames that should be combined and can consolidate them. Frame interpreters can generate simulation parameters, including rules, relationships and domains based on frame labels and entities within a frame and their inter-relations. A pathfinder module can generate legal ways generated rules and events may be executed in a simulation environment and update the simulation environment parameters accordingly.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIGS. 1A-1C illustrate a simulation system which can be used to simulate and model a mental state of a human reader of a block of text.

FIG. 2 illustrates the operations of the mental space parsers of the embodiments of FIGS. 1A-1C, including tagging the tokens of a dependency parse.

FIG. 3 illustrates the operations of the entity resolver of the embodiments of FIGS. 1A-1C in relation to an example.

FIGS. 4A-4B illustrate a method of building a simulation state from a block of text according to an embodiment.

FIG. 5 illustrates an example machine of a computer system within which, a set of instructions for causing the machine to perform any one or more of the methodologies discussed herein, may be executed.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments; however, it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The described embodiments can be used to emulate or model human-level understanding of natural language input by modeling the mental state of a human reader. The described systems and methods can interpret each piece of text it reads by building a simulation of the information presented, can store information from reading sessions in its long-term memory to be used as background knowledge for future reading sessions, can experiment to learn behaviors useful for achieving certain outcomes, and can apply previously learned behaviors in similar but not identical situations. In one respect, the described systems and methods can read and learn from a large corpus of text, then converse with a human user in natural language to summarize, discuss, and answer questions about that text. In other words, the described systems and methods can digest a body of text and construct a computer-implemented model, which simulates what the mind of a human reader would mentally construct after reading that body of text. For example, a human reader, having read an article, book or webpage constructs a mental model organizing, labeling and categorizing the information to make sense of the text.

By contrast, existing approaches to text understanding, text summarization and question-answering rely on machine learning systems, commonly deep neural networks (DNN), which do not, in practice, process textual data in a manner that human mind works. In one respect, the existing language processing systems are optimizers, using neural networks, or other optimizers to settle into a state where they can perform well on singular, well-defined problems after processing a large amount of textual data. As a result, for some problems, optimizer approaches, including neural networks, can work well. Examples include answering questions about a prompt text, where the answer can be found directly in the prompt. However, when the task requires spatial reasoning, an understanding of the passage of time, making inferences, or drawing conclusions or causal connections, these existing systems can still struggle.

Older approaches to computerized text understanding, and to Artificial Intelligence (AI) processing of text, in general, attempted to represent meaning symbolically, and to manipulate symbols and to do question-answering by way of manipulating the symbols with a large set of pre-defined logic rules. However, symbolic approaches, have not enjoyed wide-spread adoption, as statistical approaches have become more fruitful. A core problem that symbolic/logic-based systems tended to share is an ever-expanding set of rules and logic that needs to be encoded or pre-defined for every use case. These encodings often could only be generated by research specialists as the representations required for logical systems to operate on were nonintuitive. Consequently, manual updating of symbolic/logic-based systems can become unwieldy.

By contrast, while the disclosed systems and methods can use pre-defined encodings, they do also dynamically generate and update those encodings based on the textual data they process. For example, the described systems and methods can have a finite set of pre-defined rules and relationships (e.g., those which can arise from image schemas, mental spaces, and domains) and can also dynamically generate such rules and relationships based on inferences from the input text data. These rules and relationships are tractable whereas the prior symbolic systems were not. The pre-defined and dynamically derived symbols, rules or relationships can naturally represent various concepts of language and can be manipulated to solve the problems of spatial reasoning, temporal understanding, and causal connections. Purely statistical approaches, on the other hand, can struggle with generating these higher-level inferences from textual data. In some embodiments, the disclosed systems and methods use an array of neural networks tasked with transforming small units of text (frames) into image schemas, mental spaces, and domains that comprise a simulated representation of a mental space resulting from reading a block of text. The use of neural networks to identify units of meaning (e.g., mental spaces and image schemas) can eliminate the issues faced by the symbolic-based approaches that rely on rules and logic generated by humans.

In one aspect, the described systems and methods can ingest text by a pre-defined unit, such as sentence by sentence, and construct a simulation that mimics a human reader's mental model of the entities, relationships, and events described in that text. With each additional sentence that the described systems reads, the system can update the simulation using both explicit information from the new sentence and background knowledge that it has gained and organized from prior reading sessions, as well as inferences that can be drawn from one or more of these sources. In one embodiment, the described systems can use four basic units of meaning to construct and update a simulation: entities, mental spaces, image schemas and domains. In other words, the simulation of the mental space resulting from computerized reading of a body of text can be implemented by generating data constructs, such as entities, mental spaces, image schemas, domains and one or more knowledge databases.

“Entities” can refer to and encompass people, objects, abstract ideas, and nearly anything else referred to in an input text with a noun or pronoun. The described systems can perform coreference resolution to capture mentions of the same person or thing that can in turn be used to update the same simulation entity.

The described systems and methods can use “mental spaces” to model the wishes, beliefs, and goals of animate entities in the simulation, as well as complex concepts like hypotheticals and counterfactuals. The described systems can parse and identify mental spaces, an entity management system can place entities (or simulation entities) in their corresponding mental spaces within the simulation. For example, for the input text, “Julie thinks that Ardis AI will purchase Google,” the described systems can create a REALITY mental space in which “Julie,” “Ardis AI,” and “Google” all exist as entities but are not necessarily in relationship with one another. The described systems can also create a BELIEF mental space (B1) that “Julie” owns. In that mental space (B1), the described systems can also create an “Ardis AI (B1)” and a “Google (B1),” and it can set up an ENTER POSSESSION event, which will result in a POSSESSION relationship between those two entities.

The described systems can also use image schemas or data constructs that are generated in the same way a human mind can relate to the physical world. Human understanding is “embodied.” Humans talk about and understand even highly abstract ideas by using physical concepts. For example, English speakers understand the act of communication as placing ideas or thoughts into a container (e.g., spoken words, text, pictures or symbols) and transmitting that container to a listener, who then extracts the idea “substance” from the language or symbol “container.” This embodied understanding of communication uses two image schemas: CONTAINMENT and SOURCE-PATH-GOAL. From this understanding, we get sentences like: “I'm struggling to PUT my thoughts INTO words,” “I didn't GET much OUT OF that lecture,” and “her essay is excellent, but it didn't REACH her intended audience.” English speakers don't interpret any of those sentences as metaphorical in the sense of being decorative or non-literal. Humans actually use the physical of ideas of substances, containers, paths and destinations to construct and understand the act of communicating.

Using this insight, the described systems can generate image schemas as the basic units of meaning. One or more described parsers identify instances of image schemas in the text, and one or more classifiers can determine the type of each image schema (e.g., containment, surface, link, center-periphery, transformation) and can label them accordingly. An interpreter can interpret each labeled image schema instance and generate the set of relationships, rules and events that the labeled image schema entails. These generated relationships, rules and events can be added to the simulation (e.g., to the entities in the simulation, to domains or to other parts of the simulation).

The described systems can also generate domain data constructs in the simulation. Domains can refer to and include representations of subsets of information, such as color, size and speed, found in a body of text.

In some embodiments, the described systems and methods can generate, update and interact with a knowledge database. The Knowledge Database can be populated with new image schematic rules and relationships that are learned from the text during a reading session. This database can function as the long-term memory of the described systems and can be used to augment both coreference resolution and inference making. In some embodiments, the described systems can run a clustering algorithm on the knowledge database's content to identify potential higher-order concepts (e.g., COMMUNICATION is a higher-order concept composed of several image schematic relationships). In some embodiments, the described systems can run a clustering algorithm on the knowledge database's contents to identify clusters of entities with similar image schematic rules and relationships, and these clusters can be used as the basis of Natural Language Processing tasks such as Named Entity Recognition, entity disambiguation, and word-sense disambiguation.

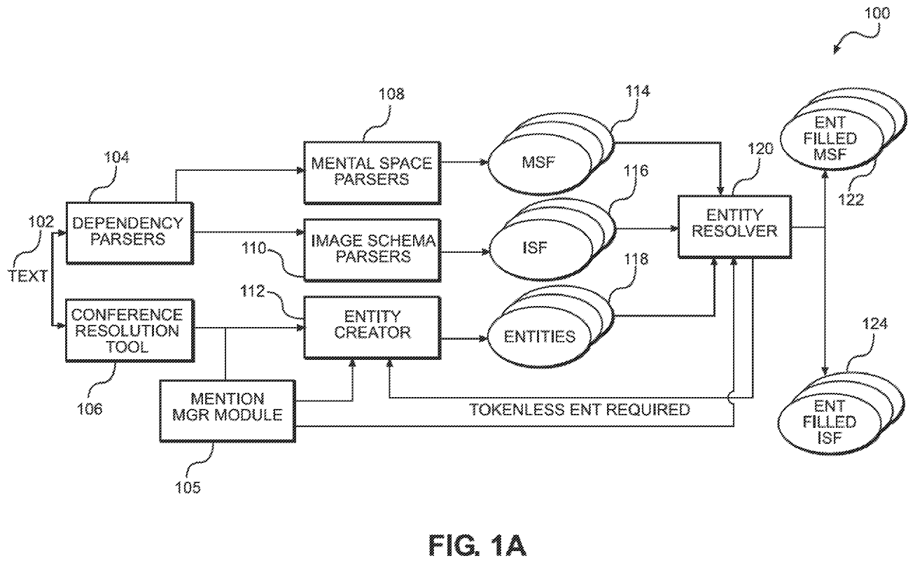

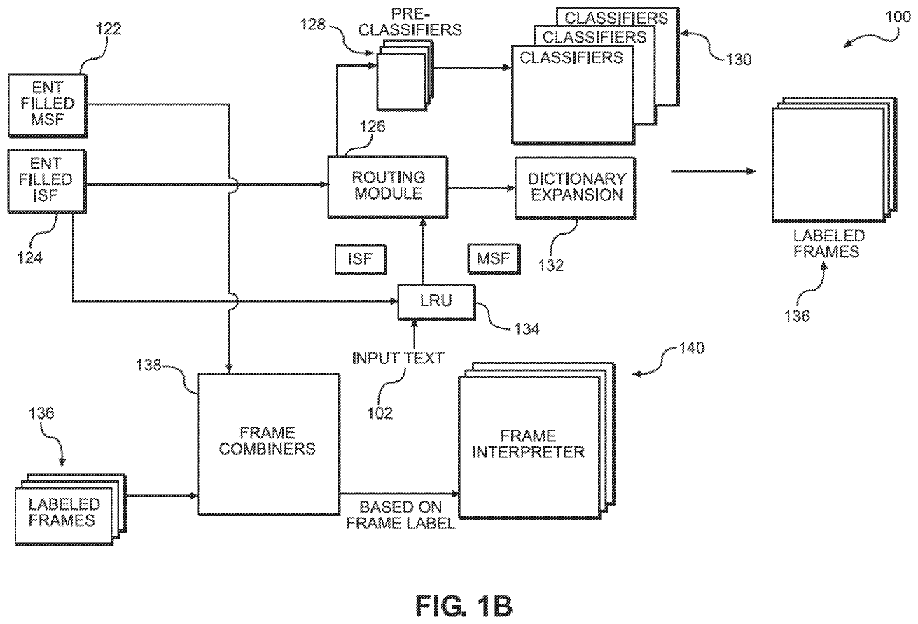

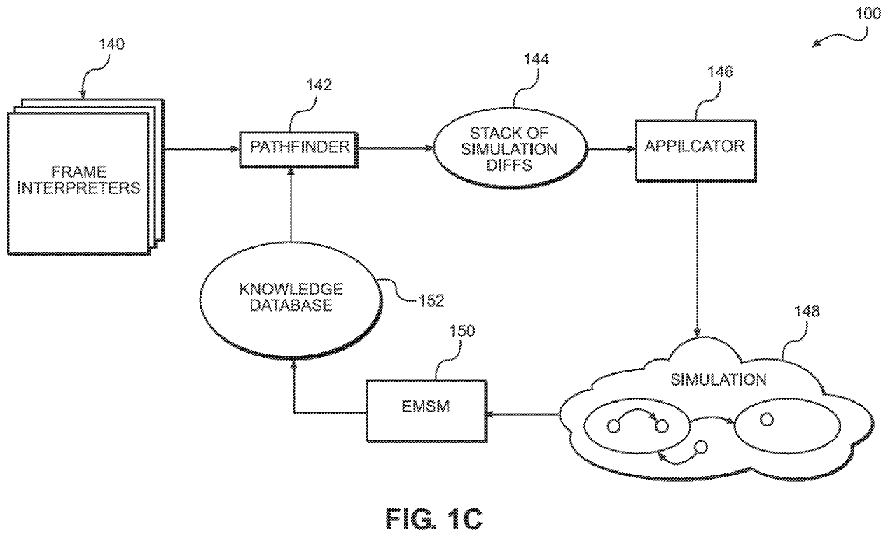

FIGS. 1A-1C illustrate a simulation system 100 which can be used to simulate and model a mental state of a human reader of a block of text. The system 100 can receive text 102 comprising one or more sentences. The text 102 is received by a dependency parser 104 and a conference resolution tool 106. The dependency parser 104 can generate a dependency parse of the input text 102. The dependency parse can include a tokenized, tagged sentence, wherein the tags can include dependency tags. An example of a dependency parse which can be generated from the dependency parser 106 can be found at https://explosion.ai/demos/displacy. The dependency parser 104 can be implemented by a variety of tools, including for example, with Stanford CoreNLP (https://stanfordnlp.github.io/CoreNLP/) of Stanford University of Palo Alto, Calif. or with spaCy (https://spacy.io/).

The conference resolution tool 106 can also be implemented with a variety of tools, including Stanford CoreNLP and spaCy. The conference resolution tool 106 can provide resolved conferences and representative mentions. Representative mentions can include initial references to entities, and resolved conferences can include information linking pronouns or later-mentioned noun references to their proper antecedents.

A mention manager module 105 can consume the representative mentions and resolved coreferences produced by the conference resolution tool 106 and process and store that information in a number of formats for later use in an entity resolver 120. The mention manager module 105 can also use representative mentions to extract entity data, such as names, corresponding tokens, token locations, gender, animacy and number. The mention manger module 105 can store that data for use in an entity creator 112.

Mental Space Parsers 108

The output of the dependency parser 104 or the dependency parse of the text 102 can be input to one or more mental space parsers 108 and image schema parsers 110. In one embodiment, the mental space parsers 108 heuristically identify instances of mental space builders (e.g., keywords that indicate a mental space or indicate a propositional attitude, such as “He WANTS to drink coffee” or “She BELIEVES that the weather will be lovely tomorrow.” In some embodiments, the mental space parsers 108 can also use verb tenses, aspect of verbs and/or adverbs of time to identify temporal mental spaces. In some embodiments, the system 100 can distinguish between temporal mental spaces and mental spaces related to propositional attitude (e.g., wishes, goals, beliefs, assertions, etc.). The mental space parsers 108 can generate mental space frames (MSF) 114 based on the identification of instances of mental space builders. Furthermore, the mental space parsers 108 generate mental space simulation objects (MSSO) in the simulation 148 (FIG. 1C) based on identification of instances of mental space builders. In one embodiment, the mental space parsers 108 store the MSSO on the dependency tokens from which the relevant spaces were generated. For example, the BELIEF mental space corresponding to the sentence “I thought you would come to dinner last night,” would be stored on the “thought” token.

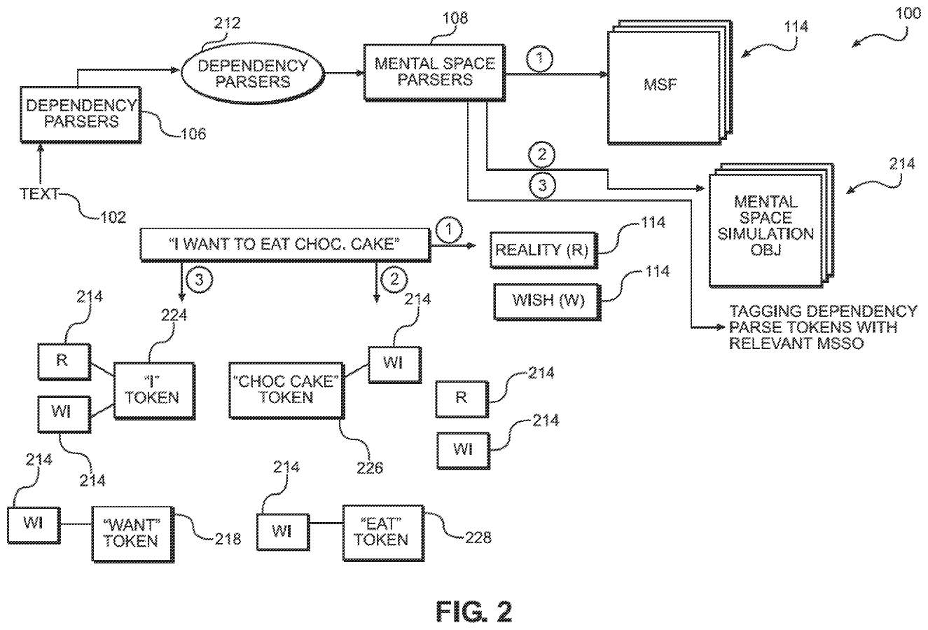

In some embodiments, the mental space parsers 108 can also tag each token in the dependency parse with information about the mental spaces in which an entity corresponding to that token should appear. FIG. 2 illustrates the operations of the mental space parsers 108, including tagging the tokens of a dependency parse. The mental space parsers 108 receive a dependency parse 212 of a block of text 102. As described earlier, the mental space parsers 108 can generate the MSFs 114. The mental space parsers 108 can also generate mental space simulation objects (MSSO) 214 corresponding to MSFs 114. The MSSO 214 are placed in the simulation 148 (FIG. 1C).

The mental space parsers 108 can also apply MSSO 214, as tags to tokens of the dependency parse 212. For example, in the sentence “I want to eat chocolate cake,” a dependency parse 212 can include tokens, such as “I,” “want,” “eat” and “chocolate cake.” MSFs are generated when a space other than the mental space “R” is used. For example, the mental space frame 114 “W1” corresponding to the speaker's declared wish mental space can be generated. In one embodiment, the mental space “R” corresponding to reality is generated for free in every simulation, and MSFs 114 are only generated when a space other than “R” is used. The mental space parsers 108 can apply MSSO 214 as tags. The “I” token 224 is tagged with both “R” and “W1” because the speaker appears in reality mental space frame “R,” but also must appear in the wish mental space frame “W1,” in which she is eating chocolate cake. The “chocolate cake” tokens 226 are only tagged with “W1” because, from the sentence alone, nothing indicates that the chocolate cake does in fact exist. In contrast, if the definite article “the” were added before “chocolate cake,” it would suggest that the speaker is referring to a specific cake that actually exists; so, the “chocolate cake” tokens would be tagged with both “R” and “W1.” But in original form of the sentence, “I want to eat chocolate cake,” the “eat” token 228 is tagged with “W1,” since the speaker is eating chocolate cake only in her wish mental space, “W1,” and not in reality. In some embodiments, a token may also be tagged with a construction tag. Construction tags maintain the source of origination of a mental space and can be looked up and used to update a mental space frame and its corresponding mental space simulation object in the simulation 148.

Image Schema Parsers 110

The image schema parsers 110 can also receive as input the dependency parse 212 of the text 102 generated by the dependency parser 104. The image schema parsers 110 can extract tuples of words that tend to indicate image schematic relationships or actions. In English, much of this information tends to cluster around prepositional phrases, e.g., “the water flowed INTO the glass” can indicate a CONTAINMENT image schema. Other instances of image schema can come from verb phrases, where the verb itself can convey the image schematic action, e.g., “the water ENTERED the glass” can also indicate a CONTAINMENT image schema. The image schema parsers 110 can use the extracted tuples of words to output image schema frames (ISF) 116 containing tokens from the dependency parse corresponding to the relevant words (e.g., “water-flowed-into-glass” or “water-entered-glass”) along with other metadata.

Entity Creator 112

Referring now to FIGS. 1A, 1C and 2, the entity creator 112 can receive as input, resolved conferences, representative mentions (e.g., as generated by the conference resolution tool 106) and the output of the mention manager module 105, including for example, entity data, such as names, corresponding tokens and token locations in the dependency parse 212, gender, animacy, number or other data that can be indicative of an entity. The entity creator 112 can generate simulation entities 118 and place them into mental spaces contained in the simulation 148. In one embodiment, all entities in the simulation 148 exist in a mental space, which may be nested within other mental spaces. The outer mental space, which contains all of the simulation, is “R” (or Reality). In some embodiments, the entity creator 112 can use the MSSO 214 applied to dependency parse tokens to determine how many copies of each entity to create and in which MSSO 214 each copy should belong to. In some embodiments, the entity creator 112 does not place references to entities into any frames. Instead, an entity resolver 120 performs that function. Entities that appear in multiple MSSO 214 are linked together as “correlated entities.” The “I” entity is marked as correlated entity in both reality MSSO 214, “R” and wish MSSO 214, “W1.” In addition to this representative-mention based entity creation, the entity creator 112 can be called by other components of the system 100 to generate inferred entities that may not be explicitly mentioned in the text 102 whose modeling can improve the simulation of a mental state of a human reader of the text 102.

In one embodiment, the entity creator 112 can also interpret role frames, where one entity can assume several roles. Therefore, in one embodiment, the entity creator 112 does not generate multiple distinct entities for multiple roles of an entity. For example, an input text 102 containing the sentence, “Tom is a father and an engineer,” can yield one entity Tom and two role frames “father” and “engineer.” So, later references to father or engineer can flag the entity, “Tom,” for processing. In one embodiment, the system 100 can include a role frame parser, as a distinct parser or as part of the image schema parser 110, which can generate and fill out role frames.

Entity Resolver 120

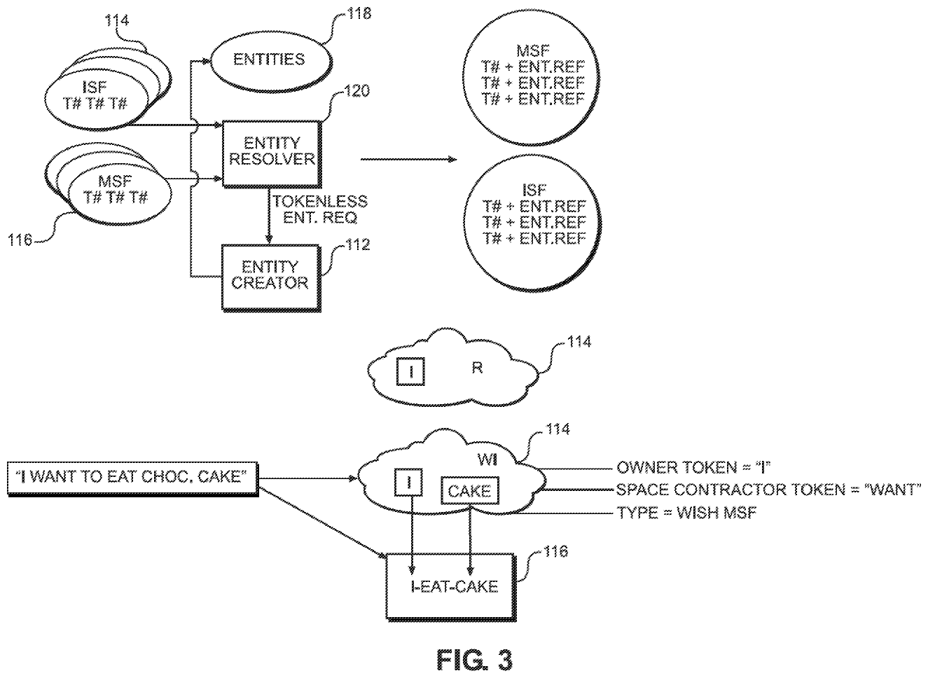

FIG. 3 illustrates the operations of entity resolver 120 in relation to an example. The entity resolver 120 receives as input, MSFs 114, ISFs 116 and entities 118 and fills the frames with references to the entities that correspond to tokens in each frame, generating entity-filled MSFs 122 and entity-filled ISFs 124 as output. For example, the image schema frame 116 corresponding to the sentence, “water flowed into glass” would contain the tokens “water” and “glass” from the dependency parse 212 when it arrives at the entity resolver 120. The entity resolver 120 can retrieve the simulation entities 118 “water” and “glass,” which were already generated and placed into their correct MSFs 114 by the entity creator 112. The entity resolver 120 can then add references corresponding to those entities to the image schema frame 116, corresponding to the sentence “water flowed into glass.”

The output of entity creator 112 can be used to determine from which MSSO 214, the entity resolver 120 should draw entities to fill an ISF. Referring to FIGS. 1A, 2 and 3, for example, the sentence “I want to eat chocolate cake” can yield MSSO 214, “R” and “W1.” The MSF 114 for “W1” has meta data references, indicating: owner token equals “I,” space constructor token equals “want” and type equals “WISH.” The sentence also yields an ISF 116 corresponding to tuple “I-eat-cake.” In this example, the entity resolver 120 scans the tags 214 associated with the “eat” token to determine from which MSSO 214, the ISF 116 associated with the tuples “I-eat-cake” should draw its entities. Referring to FIG. 2, the MSSO 214 associated with the “eat” token 228 indicates that the ISF 116 associated with the “eat” token 228 should draw its entities from MSSO 214, “W1,” and not, for example, from the “I” token 224 in MSSO 214, “R.” It is noted that in some embodiments, an MSF can be a data structure containing meta data about a mental space. The mental space itself (MSSO) is part of the simulation and contains entities. Furthermore, and as described in this example, and in some embodiments, verb tokens—if present in an ISF—are used to identify the right mental space for entity resolution. If a verb is not present, the entity resolver 120 can search for a related frame with a verb and use that verb's mental space for entity resolution.

In some cases, the coreference resolution tool 106 fails to identify a representative mention. In other instances, system modules like logical reasoning unit (LRU) 134 or the dictionary expansion 132 generate inferred frames (MSF or ISF) that are not rooted in the input text 102. If there are no existing entity for an inferred frame, or an entity that can correspond to a token in an MSF or ISF frame, the entity resolver 120 can issue a call to the entity creator 112 to generate a token-less entity, which can be used it to fill the frame. In this scenario, the entity creator 112 performs the bookkeeping associated with generation and tracing, so the newly generated token-less entity can be discovered again for later resolutions.

Routing Module 126 and Image Schema Classifiers 130

After ISFs 116 have passed through the entity resolver 120 and received references to their corresponding entities, a routing module 126 routes them to one or more image schema classifiers 130. The image schema classifiers 130 can be implemented with neural networks (NNs), deep neural networks (DNNs), or other artificial intelligence techniques. The routing module 126 can route the entity-filled ISFs 124 based on the constructor token that prompted their generation. In some embodiments, artificial intelligence networks can be trained for each constructor token. A token can correspond to a word from a parsed sentence. Example constructor tokens can include verbs, prepositions, possessive markers and possessive pronouns. In some embodiments, one or more pre-classifiers 128 can be trained and used to determine lexical aspect of image schema frames. The image schema classifiers 130 and pre-classifiers 128 (if used) can label each entity-filled ISF 124 with an image schema type, thereby generating labeled frames 136. Example image schema types include, for example, ENTER CONTAINER TRANSFER, PLACE AT LOCATION, or PRODUCTIVE SOURCE. Entity-filled MSFs 122 are not classified; instead, they are pre-labeled upon creation to provide ownership information about mental spaces and are not routed through pre-classifiers 128 or classifiers 130.

Dictionary Expansion 132 and Logical Reasoning Unit 134

In some embodiments, the routing module 126 can pass some entity-filled ISFs 124 to a dictionary expansion 132. If the system 100 detects that it has previously read and stored a definition (e.g., a set of labeled image schema and mental space frames that encode a word's meaning) for a verb in an image schema frame, the system 100 can pass that frame to dictionary expansion 132, which can apply the previously stored definition by, for example, substituting the stored list of labeled frames for the single unlabeled frame.

A logical reasoning unit (LRU) 134 can receive as input, entity-filled ISFs 124, and/or in some embodiments, the raw input text 102 or the dependency parse 212 and output additional ISFs or MSFs if it can infer new information from the input. The inferred ISFs and MSFs can be received by the routing module 126 and routed to a corresponding, relevant pre-classifier 128 and/or classifier 130. These inferred ISFs and MSFs can also be labeled by classifiers 128, 130 and generate additional labeled frames 136.

Frame Combiners 138 and Frame Interpreters 140

In some embodiments, the labeled frames 136 and the entity-filled MSFs 122 are received as input at a frame combiner 138. The frame combiner 138 can scan its input frames to determine if any can be logically combined, expanded or reordered. For example, the frame combiner 138 can identify sequences between frames, reorder them to comply with the identified sequences, identify frames linked by coordinating and subordinating conjunctions, and it can add information to frames as needed.

In some embodiments, the labeled frames 136, with or without processing by the frame combiner 138, can be routed to one or more frame interpreters 140, based on their labels. In some embodiments, each label of the labeled frames 136 can correspond to a frame interpreter 140. Frame interpreters 140 can use the labels assigned by the frame classifiers, in addition to the presence or absence of entities in the frame, to generate simulation elements such as rules, relationships, domains and events. Since rules and relationships describe interactions between simulation entities, the frame interpreters 140 are also responsible for specifying which entities the rules and relationships affect. Labels are strings used to route frames to the right frame interpreter. Relationships and rules can exist between two entities, two mental spaces, or an entity and a mental space. As an example, the sentence, “the waiter poured the wine from the bottle” can yield the ISF, [waiter-poured-wine-from-bottle], which can be labeled, “LEAVE CONTAINER TRANSFER.” The CONTAINMENT frame interpreter 140 can generate an event in simulation 148 for the wine exiting the bottle. The frame interpreter 140 can also set up image schematic rules resulting from the possibility of that event. Some example image schematic rules can include: bottles can contain wine; wine can be contained by bottles; wine can enter bottles; and, wine can leave bottles. In some embodiments, the frame interpreter 140 can establish the relationships between the “wine,” “waiter” and “bottle” entities that can exist as preconditions for the event. Example entity relationships can include: the wine is contained by the bottle; and, the waiter has agency over the bottle.

Pathfinder 142

As described earlier, the frame interpreters 140 can generate events implied by the input text 102, establish the relationships resulting from the input text 102, generate preconditions of those events, and generate the rules logically implied by the events. Using these parameters, a pathfinder 142 can find logical and/or legal ways by which those events can be executed in the simulation 148. For example, in the sentence: “Kyle walked into his apartment after a long day, and then he sat down on the couch,” the system 100 can identify two image schematic events: Kyle entering the apartment container under his own agency; and, Kyle placing himself on the couch surface. In one embodiment, the legality rules relating to CONTAINMENT and SURFACES can be pre-configured into the frame interpreter 140 and/or other components of the system 100. In one embodiment, the Pathfinder 142 can stochastically execute a number of ways to make those two events legal in sequence. For example, Kyle might enter his apartment, then leave his apartment, find the couch outside, and sit down. Or, the couch might be located inside the apartment, so Kyle may enter the apartment, find the couch within the container he shares, and place himself on the couch.

To choose a reasonable set of inferences to make, the Pathfinder 142 can query a knowledge database 152, which can contain experiences (e.g., in the form of graphs of image schematic rules and relationships). The knowledge database 152 can acquire these experiences from same or previous reading experiences and sessions. As an example, if the system 100 has previously processed many sentences in which people sit on couches that appear inside containers, such as apartments and relatively few sentences in which people sit on couches outdoors, the pathfinder 142 can make the inference that a couch is probably located inside the apartment and can select the implied chain of events to make the input text 102 legal in view of the inference about general location of couches.

In some embodiments, the Pathfinder 142 can yield a stack of simulation diffs 144 representing the events explicitly described in the input text 102, along with the inferred events that occur to make the explicit events legal. In some embodiments, simulation diffs 144 can include simulation elements or parameter changes (differentials) corresponding to events or state of the simulation 148. An applicator 146 can apply the stack of simulation diffs 144 to modify the state of parameters in the simulation 148, for example, by adding the new rules, relationships and domains that result from the explicit and inferred events.

After completing this process for each sentence frame, an experiential memory storing module (EMSM) 150 can extract from the simulation 148 sets of rules, relationships, and domains and can store them in in the knowledge database 152 for use in future reading sessions by system 100.

Furthermore, the computerized reading accomplished by system 100 can be linear or nonlinear. Linear reading in this context can refer to a reading in which each stage described above occurs once for a sentence. Not all embodiments utilize linear reading. Instead, the system 100 can be configured so that the various modules described above can listen for signals indicating changes to relevant data, allowing portions of the code to run multiple times with different assumptions for any given sentence.

The described embodiments offer multiple advantages. Use of a simulation framework using image schemas, mental spaces, and domains as a form of knowledge representation for text understanding contributes to a more robust machine processing of a body of text. For example, the described systems and methods can contribute to robust text processing and implementing machine understanding of text via features, including: identifying image schemas in text, using of neural networks to classify image schema instances, identification of instances of image schemas from a novel set of image schema sub-categories, blending of mental spaces and domains with image schemas as a form of knowledge representation, storing image schematic information in a knowledge database for use in later reading sessions and the pathfinder's method of exploring and querying the knowledge database to add explicit and simulation-inferred events.

Compared to existing approaches, purely symbolic solutions to natural language understanding can rely heavily on humans to input vast amounts of information about the world and have not shown significant promise. Purely statistical approaches also have technical challenges, for example, they require enormous amounts of training data, are trained for narrow tasks and cannot apply their learning to other domains, are difficult for human users to trust because their “reasoning” cannot be explained. More fundamentally, purely statistical approaches do not attempt to model the actual meaning of language. By contrast, the described systems and methods solve the problem of information input by using neural networks to extract and classify instances of image schemas, mental spaces, and domains, and then store the learned experiences using that knowledge representation. This approach is advantageous over existing symbolic approaches. At the same time, the embodiments describing simulation-based approaches to text understanding can be advantageous over existing statistical approaches by enabling features such as ability to learn from small amounts of text, flexibility in applying to new domains without retraining (or with few training efforts), and easily-understandable reasoning.

Additionally, while the described embodiments are explained in the context of text processing, persons of ordinary skill in the art can readily appreciate that the described systems and methods are generally applicable to any form of language processing, for example, by transcribing audio or video into text and processing the resulting natural language via the disclosed systems and methods. Therefore, the described embodiments are not limited to processing text data and are equally applicable to processing audio or video inputs.

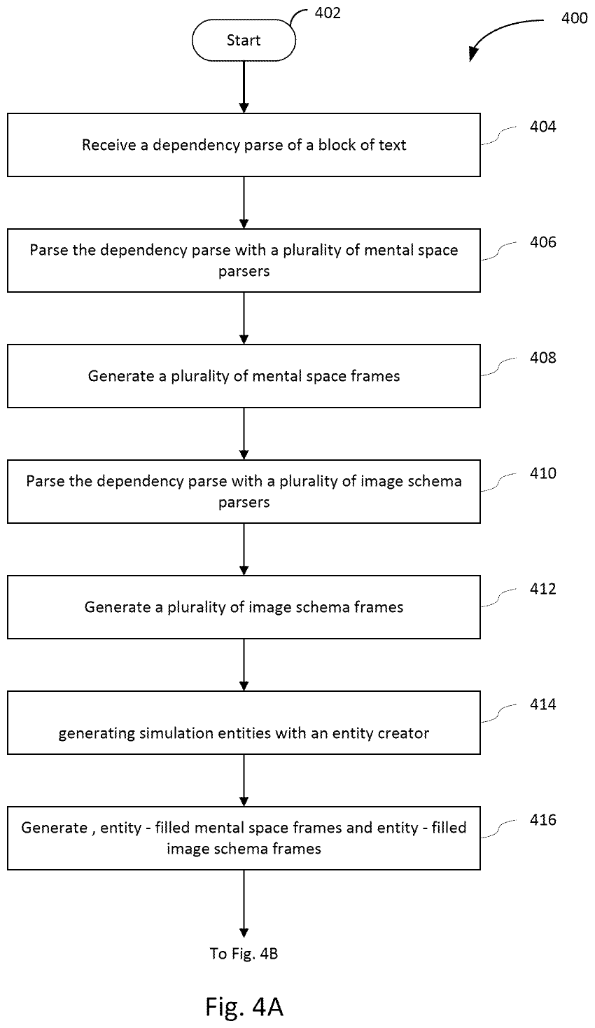

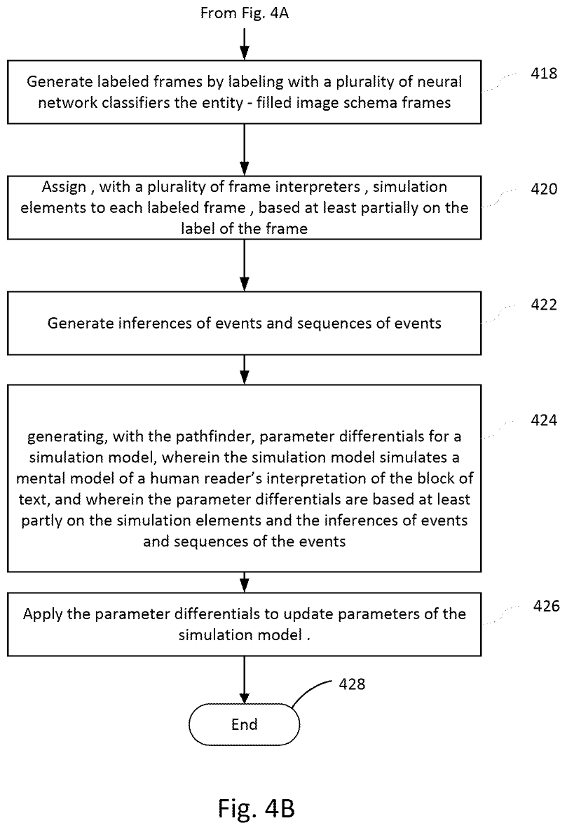

FIGS. 4A-4B illustrate a method 400 of building a simulation state from a block of text according to an embodiment. The method starts at the step 402. Step 404 includes receiving a dependency parse of a block of text. Step 406 includes parsing the dependency parse with mental space parsers. Step 408 includes generating a plurality of mental space frames. Step 410 includes parsing the dependency parse with a plurality of image schema parsers. Step 412 includes generating a plurality of image schema frames. Step 414 includes generating simulation entities with an entity creator. Step 416 includes generating, with an entity resolver, entity-filled mental space frames and entity-filled image schema frames. Step 418 includes generating labeled frames by labeling with a plurality of neural network classifiers the entity-filled image schema frames. Step 420 includes assigning, with a plurality of frame interpreters, simulation elements to each labeled frame, based at least partially on the label of the frame. Step 422 includes generating, with a pathfinder, inferences of events and sequences of events. Step 424 includes generating, with the pathfinder, parameter differentials for a simulation model, wherein the simulation model simulates a mental model of a human reader's interpretation of the block of text, and wherein the parameter differentials are based at least partly on the simulation elements and the inferences of events and sequences of the events. Step 426 includes applying the parameter differentials to update parameters of the simulation model. The method 400 ends at step 428.

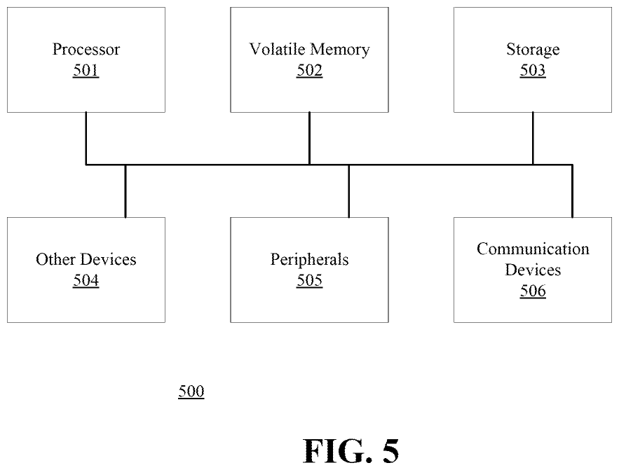

The described systems and methods can be implemented in special-purpose machines, including language processing machines (LPMs), and other special-purpose hardware, optimized for handling the processing of text. Alternatively, or in addition, the described embodiments can be implemented and used to improve the processing speed, efficiency and economy of general-purpose computers or special-purpose hardware deployed for language processing tasks. Furthermore, the described embodiments can be implemented on a single machine, for example, as described in the embodiment of FIG. 5, or they can be implemented in a network of computers. Some implementations of the described embodiments may require hardware resources that can be beyond the capabilities of a single local computer. In that scenario, the described embodiments can be implemented using a cloud provider. For example, one implementation can utilize a set of networked Docker containers on Amazon Web Services (AWS). Other cloud computing providers, for example, those optimized for language processing or artificial intelligence workload processing can also be used.

FIG. 5 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computer system 500 may further include a network interface device 508 to communicate over the network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), a graphics processing unit 522, a signal generation device 516 (e.g., a speaker), graphics processing unit 522, video processing unit 528, and audio processing unit 532.

The data storage device 518 may include a machine-readable storage medium 524 (also known as a computer-readable medium) on which is stored one or more sets of instructions or software 526 embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media.

In one implementation, the instructions 526 include instructions to implement functionality corresponding to the components of a device to perform the disclosure herein. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method of building a simulation state from a block of text, the method comprising:
receiving a dependency parse of a block of text;
parsing the dependency parse with a plurality of mental space parsers;
generating a plurality of mental space frames;
parsing the dependency parse with a plurality of image schema parsers;
generating a plurality of image schema frames;
generating simulation entities with an entity creator;
generating, with an entity resolver, entity-filled mental space frames and entity-filled image schema frames;
generating labeled frames by labeling with a plurality of neural network classifiers the entity-filled image schema frames;
assigning, with a plurality of frame interpreters, simulation elements to each labeled frame, based at least partially on the label of the frame;
generating, with a pathfinder, inferences of events and sequences of events;
generating, with the pathfinder, parameter differentials for a simulation model, wherein the simulation model simulates a mental model of a human reader's interpretation of the block of text, and wherein the parameter differentials are based at least partly on the simulation elements and the inferences of events and sequences of the events; and
applying the parameter differentials to update parameters of the simulation model.

2. The method of claim 1 further comprising generating, with a logical reasoning unit, additional labeled frames, based at least partially on detecting logical relationships in the entity-filled image-schema frames.

3. The method of claim 1 further comprising: combining, with a frame combiner, two or or more of the labeled frames, based on combination-indicating parameters comprising sequences, coordinating conjunctions, causal relationships, or temporal order.

4. The method of claim 1, further comprising generating, with a dictionary expander, labeled frames from the entity-filled image schema frames.

5. The method of claim 1, further comprising sending a request from the entity resolver to entity creator, the request comprising a request for generating an inferred simulation entity.

6. The method of claim 1, further comprising storing image schema rules, relationships and domains in a knowledge database.

7. The method of claim 1, wherein entities comprise nouns and pronouns of the text block and, wherein the method further comprises performing conference resolution to determine nouns and pronouns referring to same entities.

8. The method of claim 1, further comprising: performing conference resolution; and outputting the dependency parse of the text block, and representative mentions comprising initial references to entities and resolved conferences comprising information linking noun or pronoun references to antecedent basis of the nouns or pronouns.

9. The method of claim 1, wherein generating the image schema frames comprise detecting words, comprising prepositions.

10. The method of claim 1, wherein the mental space frames comprise wishes, beliefs and goals of the entities.

11. A non-transitory computer storage that stores executable program instructions for building a simulation state from a block of text, the instructions when executed by one or more computing devices, configure the one or more computing devices to perform operations comprising:
receiving a dependency parse of a block of text;
parsing the dependency parse with a plurality of mental space parsers;
generating a plurality of mental space frames;
parsing the dependency parse with a plurality of image schema parsers;
generating a plurality of image schema frames;
generating simulation entities with an entity creator;
generating, with an entity resolver, entity-filled mental space frames and entity-filled image schema frames;
generating labeled frames by labeling with a plurality of neural network classifiers the entity-filled image schema frames;
assigning, with a plurality of frame interpreters, simulation elements to each labeled frame, based at least partially on the label of the frame;
generating, with a pathfinder, inferences of events and sequences of events;
generating, with the pathfinder, parameter differentials for a simulation model, wherein the simulation model simulates a mental model of a human reader's interpretation of the block of text, and wherein the parameter differentials are based at least partly on the simulation elements and the inferences of events and sequences of the events; and
applying the parameter differentials to update parameters of the simulation model.

12. The non-transitory computer storage of claim 11 further comprising generating, with a logical reasoning unit, additional labeled frames, based at least partially on detecting logical relationships in the entity-filled image-schema frames.

13. The non-transitory computer storage of claim 11 further comprising: combining, with a frame combiner, two or or more of the labeled frames, based on combination-indicating parameters comprising sequences, coordinating conjuctions, causal relationships, or temporal order.

14. The non-transitory computer storage of claim 11 further comprising generating, with a dictionary expander, labeled frames from the entity-filled image schema frames.

15. The non-transitory computer storage of claim 11 further comprising sending a request from the entity resolver to entity creator, the request comprising a request for generating an inferred simulation entity.

16. The non-transitory computer storage of claim 11 further comprising storing image schema rules, relationships and domains in a knowledge database.

17. The non-transitory computer storage of claim 11, wherein entities comprise nouns and pronouns of the text block and, wherein the method further comprises performing conference resolution to determine nouns and pronouns referring to same entities.

18. The non-transitory computer storage of claim 11 further comprising: performing conference resolution; and outputting the dependency parse of the text block, and representative mentions comprising initial references to entities and resolved conferences comprising information linking noun or pronoun references to antecedent basis of the nouns or pronouns.

19. The non-transitory computer storage of claim 11, wherein generating the image schema frames comprise detecting words, comprising prepositions.

20. The non-transitory computer storage of claim 11, wherein the mental space frames comprise wishes, beliefs and goals of the entities.
